(19) United States
(12) Patent Application Publication
(10) Pub. No.: US 2022/0378030 A1
(43) Pub. Date: Dec. 1, 2022

(54) SYSTEMS FOR HOLDING FISHING RODS

(71) Applicant: Brunswick Corporation, Mettawa, IL (US)

(72) Inventors: Chad T. Keskitalo, New York Mills, MN (US); Terrence J. Weller, New York Mills, MN (US); Kyle D. Kaldor, Perham, MN (US); William A. Witt, Perham, MN (US); Alex Nelson, Zumbrota, MN (US); Matthew Sweere, Bluffton, MN (US); Brian J. Gross, Pelican Rapids, MN (US)

(73) Assignee: Brunswick Corporation, Mettawa, IL (US)

(21) Appl. No.: 16/727,560

(22) Filed: Dec. 26, 2019

(51) Int. Cl. A01K 97/10

(52) U.S. Cl. CPC A01K 97/10

(57) ABSTRACT

A system for holding fishing rods that includes a face plate having upper and lower surfaces and defining openings therethrough. Tubes are configured to each hold a fishing rod, where each of the tubes extends along a central axis from an open end to a bottom end. The tubes are receivable within the openings in the face plate. Each of the tubes has an engagement feature for coupling the tube to the face plate such that the open end is aligned with one of the openings in the face plate. For each of the tubes the open end is closer than the bottom end to the face plate, and one of the fishing rods extends through the face plate and into one of the tubes when held by the system.

### FIELD

The present disclosure generally relates to systems for holding fishing rods, and more particularly to systems having a face plate configured to be coupled to tubes for holding the fishing rods.

### BACKGROUND

The following U.S. Patents and Patent Applications provide background information and are incorporated by reference in entirety.

U.S. Pat. No. 3,964,706 discloses a holder assembly for a fishing rod or the like, including a number of readily replaceable elements adapted to hold any standard fishing rod during actual fishing, as in trolling, and safely store the rod while cruising to and from the fishing grounds, the assembly comprising a mounting base with keyhole connecting means for quickly attaching to or detaching from a supporting surface, a tubular socket on the base, an elongated sleeve for slidably receiving and holding a fishing rod handle, and means for readily securing and detaching the sleeve to and from said socket. The substitution of another sleeve having a portion with a larger diameter enables the holding of larger and heavier fishing rods. The substitution of another mounting base having a different angular arrangement of the tubular socket renders the holder assembly readily mountable on vertical, horizontal or angled supporting surfaces of a boat and permits the changing of the angular position of the held fishing rod.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One embodiment of the present disclosure generally relates to a system for holding fishing rods that includes a face plate having upper and lower surfaces and defining openings therethrough. Tubes are configured to each hold one of the fishing rods, where each of the tubes extends along a central axis from an open end to a bottom end. The tubes are receivable within the openings in the face plate. Each of the tubes has an engagement feature for coupling the tube to the face plate such that the open end is aligned with one of the openings in the face plate. For each of the tubes the open end is closer than the bottom end to the face plate, and the system is adapted such that one of the fishing rods extends through the face plate and into one of the tubes when held by the system.

Various other features, objects and advantages of the disclosure will be made apparent from the following description taken together with the drawings.

### BRIEF DESCRIPTION OF THE DRAWINGS

The present disclosure is described with reference to the following Figures.

FIG. 1 is an isometric side view of an exemplary system for holding fishing rods according to the present disclosure in assembled form;

FIG. 2 is a close-up isometric view showing one tube partially installed within a faceplate to create the assembly of FIG. 1;

FIG. 3 is a sectional side view taken along the line 3-3 from FIG. 2; and

FIG. 4 is a sectional side view similar to that shown in FIG. 4, now showing the tube fully installed within the faceplate.

### DETAILED DISCLOSURE

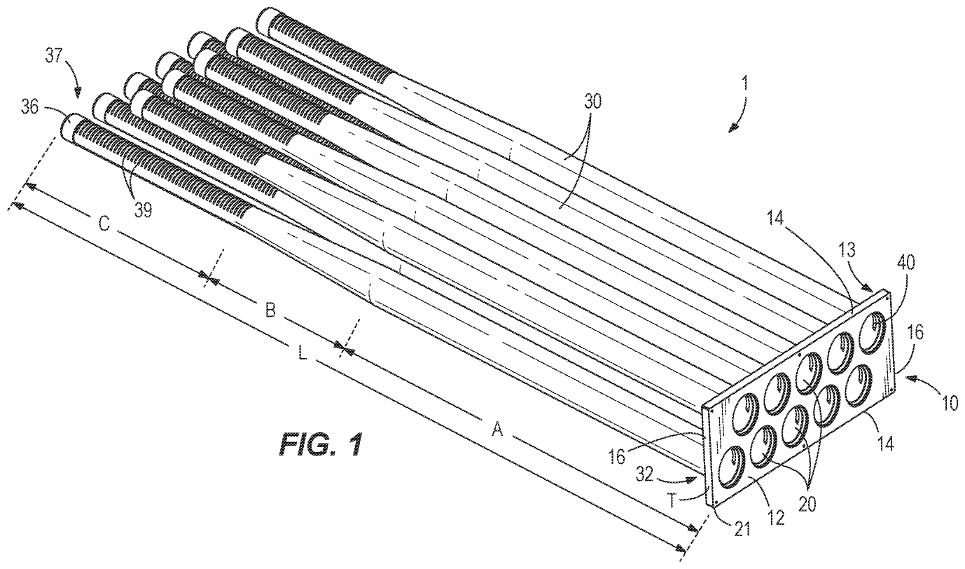

FIG. 1 shows an exemplary system 1 for holding fishing rods, which would be mountable to a fishing boat. The system 1 includes a faceplate 10 having an upper surface 12 and a lower surface 13 that defines a thickness T therebetween. The faceplate 10 further extends between long ends 14 and short ends 16. A series of openings 20 are defined through the faceplate 10, which also has mounting features 21 for coupling the faceplate to another object (such as a fishing boat) for example through the use of various fasteners such as bolts or screws. In the present case, the faceplate 10 is shown to have ten openings 20 each configured to hold a fishing rod or other accessory (i.e., a fishing net) therein.

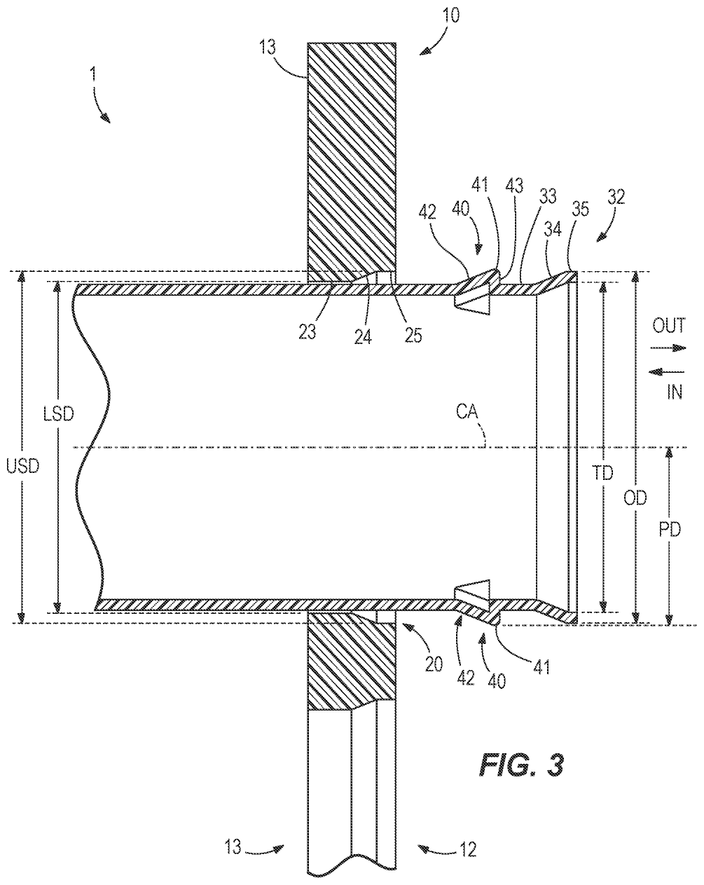

The system 1 further includes a series of tubes 30 that each extend along a central axis CA (FIG. 3) between an open end 32 and a bottom end 37 to have an overall length L. In the embodiment shown, each of the tubes 30 has three distinct sections along the length L: a first section A having a substantially constant diameter, a downwardly tapering second section B, and a third section C having a substantially constant diameter that is smaller than that of the first section A. In the embodiment shown, each of the tubes 30 has score lines 39 within the third section C such that the length L may be easily adjusted, for example by cutting or snapping the tube 30 at one of the score lines 39, to meet the needs of the consumer. Each of the tubes 30 is further outfitted with an end cap 36 at the bottom end 37. The end cap 36 in certain embodiments has a press fit that allows for removal to drain or clean the tube 30. The end cap 36 may also have a drain hole defined therein.

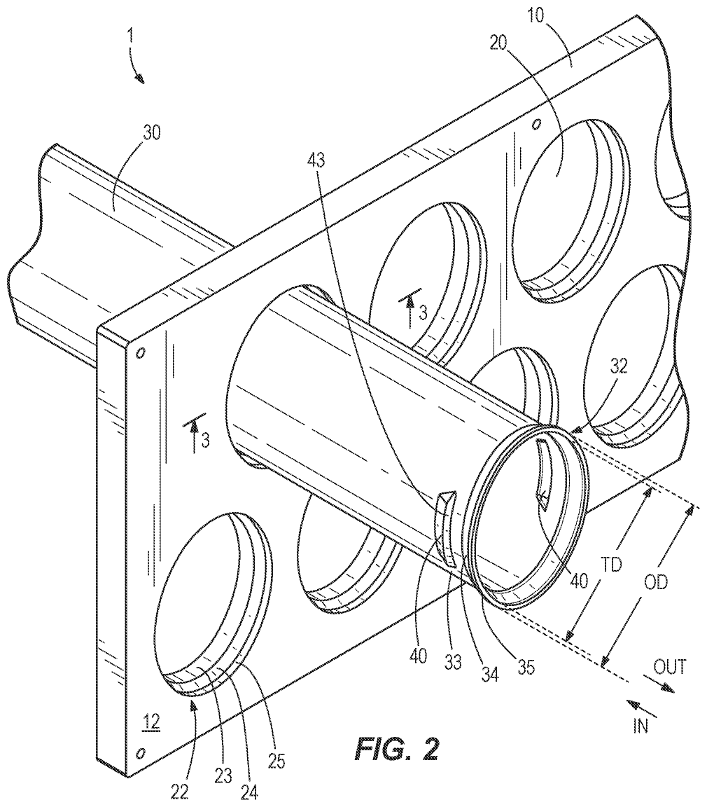

As shown in FIGS. 1-2, each of the tubes 30 is received within one of the openings 20 defined in the faceplate 10 such that the open end 32 of the tube 30 is substantially proximal to the faceplate 10. As is discussed further below, each of the tubes 30 further includes an engagement feature 40 for coupling the tube 30 to the faceplate 10 such that the open end 32 remains aligned with one of the openings 20 in the faceplate 10. In this manner, a fishing rod is held within the system 1 by inserting a tip (opposite a handle) of the fishing rod through the faceplate 10, and further into one of the tubes 30 via its corresponding upper end 32.

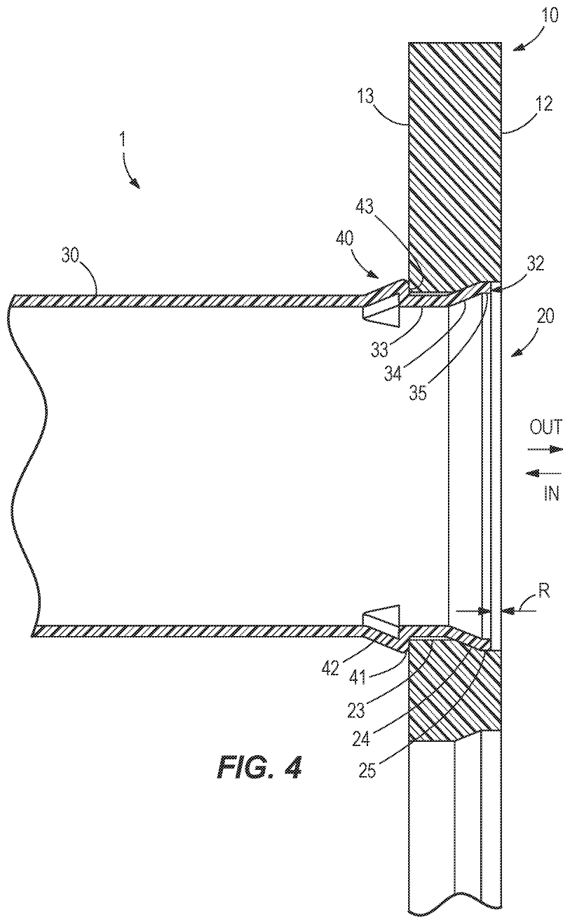

As best shown in FIG. 2 and the progression from FIG. 3 to FIG. 4, each tube 30 is retained within the faceplate 10 through one or more engagement features 40. In the embodiment shown, the engagement feature 40 is a tab extending radially away from each of the tubes 30. The engagement feature 40 is dimensioned to limit axial movement of the tube 30 in the outward direction OUT (to remove the tube 30) once the tube 30 has been coupled to the faceplate 10. In the embodiment shown, best exemplified in FIGS. 3 and 4, the engagement feature 40 has a face 43 that extends upwardly from the tube 30 to a peak 41, whereby the face 43 abuts the lower surface 13 of the faceplate 10 to prevent movement of the tube 30 in the outward direction OUT once inserted. The peak 41 extends a peak distance PD from the central axis CA of the tube 30 and tapers downwardly back to the tube 30 via a transition 42. The diameter of the tube 30 at the point in which the tube 30 engages the lower surface 13 of the faceplate 10 when the tube 30 is coupled thereto is referred to as the through diameter TD.

Returning to FIG. 2, the tube 30 (and particularly near its open end 32) can be described as having a first region 33, second region 34, and third region 35. The first region 33 corresponds to the through dimension TD of the tube 30, the third region 35 corresponds to the open diameter OD at the open end 32 of the tube 30, and the second region 34 provides a transition therebetween. Likewise, the opening 20 within the faceplate 10 has a first region 23, second region 24, and third region 25 corresponding to the first region 33, second region 34 and third region 35 of the tube 30, respectively. Differences between the respective diameters of regions within the opening 20 and those of the tube 30 account for tolerances and desired clearances for ease of installation and a tight fit therebetween.

In this manner, the openings 20 extend between an upper side diameter USD that accommodates the third region 35 of the tube 30 and a lower side diameter LSD for the first region 33. Since the open end diameter OD of the tube 30 is greater than the through diameter TD, the opening 20 limits the axial movement of the tube 30 in the inward direction IN through engagement of corresponding regions of the opening 20 and tubes 30.

In certain embodiments, such as those discussed above, the engagement feature 40 is resilient, for example made of a polymer. Due to this resiliency, the peak distance PD between the peak 41 of the engagement feature 40 and the central axis CA of the tube 30 is reducible with force, for example by inserting the tube 30 inwardly through one of the openings 20 in the faceplate 10 as the engagement feature 40 passes through the opening 20. It will be recognized that once the peak 41 of the engagement feature 40 has passed entirely through the opening 20, the resilient nature of the engagement feature 40 provides that the peak 41 springs outwardly to its full peak diameter PD. At this point, the face 43 of the engagement feature 40 abuts the lower surface 13 of the faceplate 10 to prevent outward axial movement of the tube 30 relative to the faceplate 10.

In certain embodiments, the second region 34 of the tube 30 (and likewise the second region 24 of the opening 20) are angled, such as shown in FIGS. 2-4. However, it should be recognized that the same function may be provided by any transition between the lower surface diameter LSD and the upper surface diameter USD of the openings 20 (and likewise between the through diameter TD and open end diameter OD of the tubes 30). For example, the transition provided in the second region 24 of the opening 20 (and likewise the second region 34 of the tube 30) may be perpendicular to the first region 23 and first region 33 of the tube 30.

In certain embodiments, the open end 32 of the tubes 30 are flush or below the upper surface 12 of the faceplate 10. For example, FIG. 4 depicts a configuration in which a recess R remains between the open end 32 of the tube 30 and the upper surface 12 of the faceplate 10 when the tube 30 is fully coupled therein. Alternatively, further embodiments may provide that the open end 32 of the tube 30 remains above the upper surface 12 of the faceplate 10, such as configurations having a lip (not shown) or flange-type feature.

In certain embodiments, the resilient nature of the engagement feature 40 further provides that the tubes 30 are removable from the faceplate 10 by compressing the engagement features 40 inwardly until the peak 41 is receivable within the opening 20. Likewise, in embodiments in which the engagement feature 40 is a threaded coupling between a tube 30 and opening 20, the tubes 30 may be threadedly removable.

The present inventors have identified that the presently disclosed system 1 is particularly advantageous in the manufacturing, shipping, and storage of fishing rod holders. For example, fishing rod holders presently known in the art are shipped from a manufacturer to a retailer or customer as a completed assembly, which is bulky and thus expensive. This also increases the risk of damage in transit or storage if tubes 30 are bumped, whereby cracking may occur. The system 1 presently disclosed provides that tubes 30 and faceplates 10 may be individually shipped from the manufacturer, installable on location by a retailer or boat outfitter, or by an end user themselves. Moreover, if damage occurs to a single tube 30 within the overall system 1, that individual tube 30 may be replaced without the need to uninstall other tubes 30 or the faceplate 10. This in turn saves expenses from shipping systems, as well as extending the usable life of a system 1 in service by allowing for some level of replacability.

This written description uses examples to disclose the invention, including the best mode, and also to enable any person skilled in the art to make and use the invention. Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

1. A system for holding fishing rods, the system comprising:
a face plate having an upper surface and a lower surface and defining openings therethrough, wherein the openings each taper inwardly from an upper surface diameter at the upper surface to a lower surface diameter at the lower surface;
a plurality of tubes each configured to hold one of the fishing rods, wherein each of the plurality of tubes extends along a central axis from an open end to a bottom end, wherein exteriors of the plurality of tubes each taper inwardly from the open end to correspond with the tapering of the openings in the face plate, wherein the plurality of tubes are receivable within the openings in the face plate, and wherein each of the plurality of tubes has an engagement feature for coupling the tube to the face plate such that the open end is aligned with one of the openings in the face plate;
wherein for each of the plurality of tubes the open end is closer than the bottom end to the face plate, and wherein the system is adapted such that one of the fishing rods extends through the face plate and into one of the plurality of tubes when held by system; and
wherein interiors of the plurality of tubes each taper inwardly from the open end so as to guide the one of the fishing rods into the one of the plurality of tubes.

2. The system according to claim 1, wherein for each of the plurality of tubes the open end extends at most to being flush with the upper surface of the face plate. 3-4. (canceled)

5. The system according to claim 1, wherein the engagement feature is a tab extending away from each of the plurality of tubes, wherein an outward direction is defined from the bottom end of the tube to the open end, and wherein the tab is dimensioned to limit axial movement of the tube in the outward direction.

6. The system according to claim 5, wherein the tab abuts the lower surface of the face plate.

7. The system according to claim 6, wherein each of the plurality of tubes has a through diameter where the tube engages the lower surface of the face plate when coupled thereto, therein the tab has a peak extending a peak distance from the central axis of the tube that is greater than half the through diameter, and wherein the peak limits the axial movement of the tube in the outward direction.

8. The system according to claim 7, wherein the tab is resilient such that the peak distance is reducible with force, wherein the peak distance is reduced by inserting the tube through one of the openings in the face plate until the tab passes through the lower surface thereof.

9. (canceled)

10. The system according to claim 1, wherein the exteriors of the plurality of tubes tapering inwardly and the openings tapering inwardly limit axial movement of the plurality of tubes opposite the outward direction when the plurality of tubes are coupled to the faceplate.

11. The system according to claim 1, wherein the openings in the face plate have circular cross-sections, and wherein the exteriors at the top open ends of the plurality of tubes have circular cross-sections.

12. The system according to claim 1, wherein the openings in the face plate taper inwardly guide the one of the fishing rods into the open end of one of the plurality of tubes.

13. The system according to claim 1, wherein for each of the plurality of tubes the open end has a first diameter and the bottom end has a second diameter that is less than the first diameter so as to guide the one of the fishing rods into the one of the plurality of tubes.

14. The system according to claim 1, wherein the plurality of tubes have lengths and also have score lines closer to the bottom ends than to the open ends, wherein the score lines at which the plurality of tubes are configured to snap to reduce the lengths thereof.

15. A system for holding fishing rods, the system comprising:
a face plate having an upper surface and a lower surface and defining openings therethrough;
a plurality of tubes each configured to hold one of the fishing rods, wherein each of the plurality of tubes extends along a central axis from an open end to a bottom end, wherein the plurality of tubes are receivable within the openings in the face plate, and wherein each of the plurality of tubes has an engagement feature for coupling the tube to the face plate such that the open end is aligned with one of the openings in the face plate;
wherein for each of the plurality of tubes the open end is closer than the bottom end to the face plate, wherein the system is adapted such that for each of the plurality of tubes coupled to the face plate the engagement feature is closer than the face plate to the bottom end, and wherein the system is adapted such that one of the fishing rods extends through the face plate and into one of the plurality of tubes when held by the system; and
wherein the plurality of tubes have lengths and also have score lines closer to the bottom ends than to the open ends, wherein the score lines at which the plurality of tubes are configured to snap to reduce the lengths thereof.

16. The system according to claim 15, wherein the openings in the face plate have circular cross-sections, and wherein exteriors of the open ends of the plurality of tubes have circular cross-sections.

17. The system according to claim 16, wherein the exteriors of the bottom ends of the plurality of tubes have circular cross-sections.

18. The system according to claim 15, wherein for each of the plurality of tubes the open end tapers inwardly so as to guide the one of the fishing rods into the one of the plurality of tubes.

19. The system according to claim 15, wherein for each of the plurality of tubes the open end has a first diameter and the bottom end has a second diameter that is less than the first diameter so as to guide the one of the fishing rods into the one of the plurality of tubes.

20. A system for holding fishing rods, the system comprising:
a face plate having an upper surface and a lower surface and defining openings therethrough, wherein the openings have circular cross-sections and taper inwardly from an upper surface diameter at the upper surface to a lower surface diameter at the lower surface, and wherein an outward direction is defined from the lower surface to the upper surface;
a plurality of tubes configured to be receive within the openings in the face plate and each configured to hold one of the fishing rods, wherein each of the plurality of tubes extends along a central axis from an open end to a bottom end each having a circular cross-section, wherein exteriors of the plurality of tubes each taper inwardly from the open end to correspond with the tapering of the openings in the face plate, and wherein interiors of the plurality of tubes each taper radially inwardly from the open ends to the bottom ends so as to guide the fishing rods into the plurality of tubes;
a plurality of tabs extending radially away from the plurality of tubes and configured to abut the lower surface of the face plate when the plurality of tubes are received within the openings in the face plate, wherein the plurality of tabs engaging the lower surface of the face plate limit axial movement of the plurality of tubes in the outward direction;
wherein for each of the plurality of tubes the open end extends at most to being flush with the upper surface of the face plate; and
wherein the system is adapted such that one of the fishing rods extends through the face plate and into one of the plurality of tubes when held by the system, and wherein the plurality of tubes have lengths and also have score lines closer to the bottom ends than to the open ends, wherein the score lines at which the plurality of tubes are configured to snap to reduce the lengths thereof.
